(19) United States
(12) Patent Application Publication
(10) Pub. No.: US 2010/0114976 A1
(43) Pub. Date: May 6, 2010

(54) Method For Database Design

(76) Inventors: Maria G. Castellanos, Sunnyvale, CA (US); Neal A. Coddington, Novato, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/255,608

(22) Filed: Oct. 21, 2008

(51) Int. Cl. G06F 17/30; G06F 7/00

(52) U.S. Cl. 707/803; 707/E17.044; 707/E17.017

(57) ABSTRACT

Embodiments in accordance with the present invention include methods and systems for database design. A method includes analyzing tables to generate recommendations for an initial design of a database before the database is constructed.

### BACKGROUND

The physical design of a database is a very time consuming and cumbersome task that is typically performed in an iterative fashion. The physical design is frequently done manually by trial and error. In the best case, time is spent on analyzing the performance related aspects of the physical design before creating the database. Effort is put into doing predicate analysis on sample Structured Query Language (SQL) statements that constitute the workload imposed on the Database State Machine (DBSM) by the user community. Doing so leads to a reasonably good physical design on the first iteration and reduces the time spent on the following iterations. Moreover, it is often the case that the design needs to be revised later when the database is in operation to improve the performance of the workload execution. These later revisions are needed because the nature of the data changes as does the nature of the workload to a greater or lesser extent depending on the purpose of the database.

A given database design can go through many revisions during and after the initial implementation. The consequence of revising the physical design can mean the database needs to be recreated and the data reloaded. This process is very costly in terms of time and human resources. Because of this cost projects can be delayed or the decision can be made to simply go with an inferior design obtained under a time constraint. In either case, the physical design phase can be costly and time consuming.

Accordingly, accurate and scalable methods and systems for database design are desirable.

### BRIEF DESCRIPTION OF THE DRAWINGS

FIG. 1 is a flow diagram for designing a database in accordance with an exemplary embodiment of the present invention.

FIG. 2 is an overview of system architecture implementing a database design advisor in accordance with an exemplary embodiment of the present invention.

FIG. 3 is a flow diagram of database design recommendations provided by a database design advisor in accordance with an exemplary embodiment of the present invention.

FIG. 4 is an overview of architecture of a database design advisor in accordance with an exemplary embodiment of the present invention.

FIG. 5 is a block diagram of an exemplary computer system in accordance with an embodiment of the present invention.

### DETAILED DESCRIPTION

Exemplary embodiments in accordance with the present invention are directed to systems and methods for automatically generating physical design recommendations for a data warehouse or Online Transaction Processing (OLTP) database. One exemplary embodiment provides a software tool for designing physical features of a database, such as clustering keys, partitioning keys, secondary indexes, cover indexes, and materializing views.

One exemplary embodiment is an upfront design advisor that does not need a query optimizer, runtime statistics, or even an existing database to provide recommendations or design criteria for a database. Instead, exemplary embodiments use the query workload and flat file statistics as input to design the database. One embodiment provides design recommendations before the database is actually created (as opposed to a software tool that is used to tune and improve a database after it is already designed and loaded). Hence, exemplary embodiments can be used even before the data is loaded into the database since design recommendations are provided without a corresponding database system installation.

One exemplary embodiment autonomously recommends the clustering keys, partitioning keys, secondary indexes, cover indexes, and materialized views for a database using algorithms based on the standard practices of a database design administrator (DBA). Exemplary embodiments also provide detailed rationale or explanations for each recommendation to help DBAs get a good understanding of the recommendations and make the correct decisions on whether to follow the recommendations or not.

Exemplary embodiments are provided as a database design advisor (DBDA). The DBDA is a zero-risk advisor in a sense that the primary key is not augmented (the exception is when the database follows a dimensional model and the primary key of a fact table is augmented with the primary key of a dimension table). In some databases, the partitioning key is required to be a subset of the primary key. As a result, if the partitioning key includes a column outside the primary key, the primary key is augmented with that column. A database administrator (DBA) can augment the primary key after looking at the results of the DBDA, but in one embodiment that decision is not made by the DBDA.

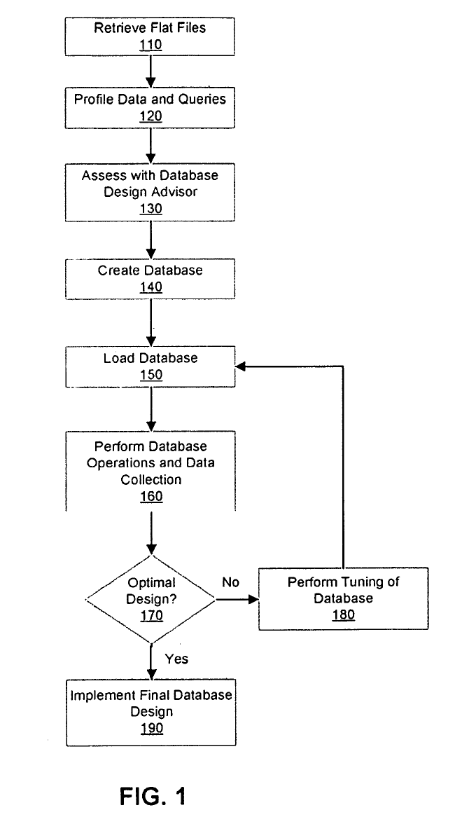

FIG. 1 is a flow diagram for designing a database in accordance with an exemplary embodiment of the present invention.

According to block 110, flat files and other information are collected or received. The flat files include records and field instances for the database to be designed. In one embodiment, the DBDA designs the database after receiving two categories of information: the files with the records and the corresponding table schemas. The tables schemas represent the logical design of the database.

According to block 120, the received data and queries are profiled. In one embodiment, the profile includes unique entry count (UEC) values of both individual columns and column groups along with skew factors of some columns and column groups as well as predicate information of the queries in the workload.

According to block 140, the information is presented to a database design advisor (DBDA). The DBDA analyses the profiles to determine an efficient and cost effective design for the database.

In one embodiment, the DBDA is not based on or connected to a preexisting database. Instead, the recommendations are provided for the initial design of the database. These recommendations (such as the clustering key, partitioning key, indexes, and materialized view) are provided for each table. Along with each recommendation, an explanation or rationale is provided so a user or DBA can understand the recommendation and make an informed decision as to whether to accept or reject the recommendation.

In one embodiment, after a recommendation is accepted, the DBDA automatically creates the code for the recommendation (for example, creates the code in Structured Query Language, SQL). A script is created for the recommendation, and the script produces the Data Definition Language (DDL).

According to block 140, the database is created. Here, a user or DBA receives and analyzes the recommendations to determine which recommendations to implement in the design of the database. The accepted recommendations are used to create the database.

According to blocks 150 and 160, the created database is loaded and data operations commence. During this time, performance data (such as query execution times) is collected and provided to the DBA. A decision is then made according to block 170 as to whether the database is optimally executing. If the answer to this question is “no” then flow proceeds to block 180, and the database is further tuned. If the answer to this question is “yes” then flow proceeds to block 190, and the design of the database is completed.

In one embodiment, the physical design of a database is defined as follows: given a logical database design, a workload (i.e., set of queries) imposed on the database, the data profiles, and a disk space constraint, exemplary embodiments determine an optimal set of physical structures (optimal configuration) including clustering keys, partitioning keys, indices and materialized views that meet the performance requirements.

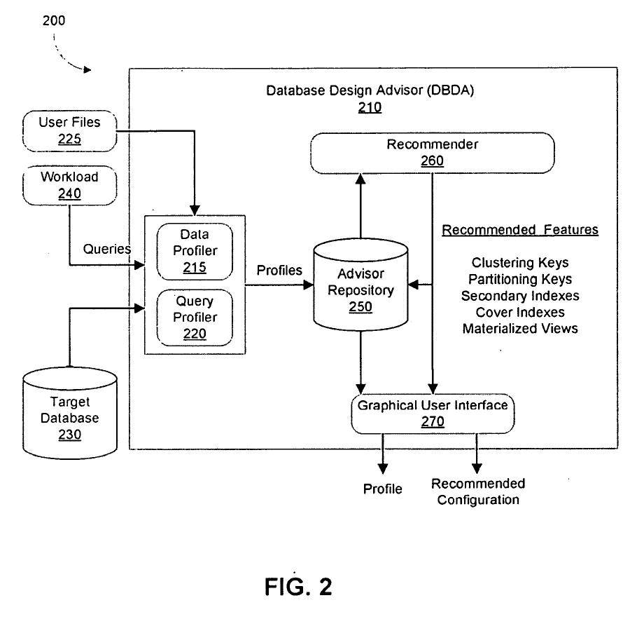

Exemplary embodiments automate the initial physical database design based on a representative workload, data and logical design (the design being subject to disk space constraint). This automation is embodied in a database design advisor 210 (DBDA) depicted in FIG. 2 which provides an overview of system architecture 200 in accordance with an exemplary embodiment of the present invention.

A data profiler component 215 analyzes data to obtain relevant statistics for the attributes or groups of attributes in the query predicates. These statistics are the unique entry counts (UECs) and the data skews. The data profiled can come from flat files, user files 225, or from the actual data in a live database 230.

A query data profiler component 220 replaces the manual and time consuming step of breaking down the queries of a workload 240 to analyze the exact usage of predicate attributes and other items. Each and every query is decomposed and profiled by table, column, and role. The queries are individually profiled and those profiles can be aggregated into a summary.

The profilers extract the relevant profile including tile UEC and skew values of columns (data profile) and predicate information of the queries in the workload (query profile) and store the extracted information in an advisory repository 250. In one embodiment, all the metadata (profiles) gathered by the two profilers is stored into the advisor repository 250. This profile information is then used by a recommender 260 to produce suggestions for clustering keys, partition keys, indices and materialized views. The recommender generates Data Definition Language (DDL) script to create the database based oil the suggestions.

In one embodiment, the recommender 260 is a knowledge-based system that captures the common practices and heuristics of physical database design experts into a set of algorithms. Each algorithm is refined and enhanced using costs based on the actual data and query profiles. The recommender 260 shows all the algorithms, costs, and rational for each and every recommendation via a Graphical User Interface (GUI) 270.

In one embodiment, the DBDA 210 analyzes the profiles and returns the recommended features to the user via the GUI 270. If the user accepts the recommendations, they can be implemented when creating the database. After the database is created, the flat file data is loaded in the database according to the physical design.

By utilizing the DBDA 210, an initial physical database is generated with accuracy, efficiency, and scalability. The accuracy is at least as good as the one that could be manually obtained by a human expert. The efficiency is realized by optimizing the algorithms and the access to the data in the advisor repository so that the recommendations are generated in only a few hours or even minutes. Manual analysis limits the number of queries that can be profiled as well as the number of design alternatives that can be explored. The DBDA is scalable in that it can easily expand to profile hundreds of tables and thousands of queries and to explore thousands of alternatives.

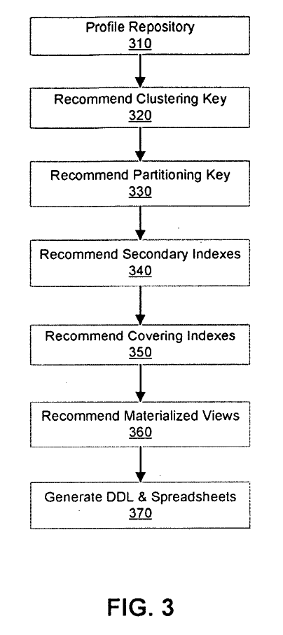

FIG. 3 is a flow diagram of database design recommendations provided by a database design advisor in accordance with an exemplary embodiment of the present invention.

According to block 310, the flat files and workload of data are provided to a profiler and profiled. The DBDA retrieves and analyzes the profiled information to provide various recommendations to design the database.

In one embodiment, the DBDA receives information on the primary key and advises or recommends on the clustering key (also called the primary key column ordering)) according to block 320, the partitioning key according to block 330, secondary indexes according to block 340, cover indexes according to block 350, and materialized views according to block 360.

In one embodiment, the clustering key and partitioning key provide the foundation for the physical database design. Proper clustering in the design provides densely packed rows that satisfy queries while partitioning is used to efficiently execute parallel processing. These two features are also relatively costly to change after the database is designed. For example, it can be costly in terms of time and resources to fully reorganize a massive database in order to re-cluster or re-partition the data whereas it is relatively easier to build a new index. Hence, exemplary embodiments provide recommendations and information to make correct decisions for the clustering and partitioning keys first.

The next features to consider are the secondary indexes, cover indexes, and materialized views (shown in blocks 340, 350, and 360). A secondary index provides an alternative access path (other than via the primary key) to the base table. A cover index is a vertical partition of a table. The cover index will contain a subset of columns from the base table that are most frequently used to completely satisfy queries. Using a cover index saves the time to read base table records from the disk. Materialized views are the materialization of query results to avoid re-computing them.

According to block 370, the DBDA produces a DDL file to create the database according to the recommendations and a spreadsheet that summarizes all the recommendations. In one exemplary embodiment, the recommendations are performed sequentially.

The DBDA also provides detailed rationale for each recommendation. This feature assists the DBA to make correct design choices and possibly alter the suggested design. For each recommendation, the DBDA shows the reasoning for the recommendation and the equations that it used for calculating various costs (e.g., join cost, index benefit). The DBA has some flexibility to change the design by changing the ordering of the clustering key or selecting/deselecting indexes.

In one embodiment, the clustering key determines an ordering of the primary key columns in each of the tables. In one embodiment, the columns are ordered to increase efficiency of the database (for example, increase the speed at which data records are retrieved from the tables in response to a query). A recommendation is provided that gives the order of the primary key columns for each table.

In one embodiment, the created database system includes multiple processes (for example, plural processors) and multiple storage devices (for example, plural disks or disk arrays). The partitioning key determines the column or columns to use to divide the tables to maximize collocation and where to store the partitions across the various storage devices. A recommendation is provided for the partitioning key of each table that is worth partitioning.

In one embodiment, the indexes are auxiliary structures that decrease the total access time to retrieve data from the tables in response to a query. In other words, indexes enable records to be more quickly retrieved by providing information about the location of records. In one embodiment, not every column is associated with an index as this would add to the overall cost of the database (for example, add to the storage and add to the time required to update each index when new records are obtained). The DBDA provides recommendations on which individual columns or combinations of columns receive an index.

In one embodiment, the materialized views are auxiliary structures that materialize results from previously executed queries so subsequent execution of the same queries is readily obtained. Once a query is run, the results are stored, for example by creating a new table. Then, when the same query is received at a later point in time, the records are immediately retrieved from the created table (as opposed to executing the query through the tables in the database). Materialization of views has a cost that includes both storage space (i.e., storing the materialized views) and maintenance (i.e., updating the views as records change). The DBDA determines which queries or parts of queries should be materialized in order to increase the efficiency and speed of the database.

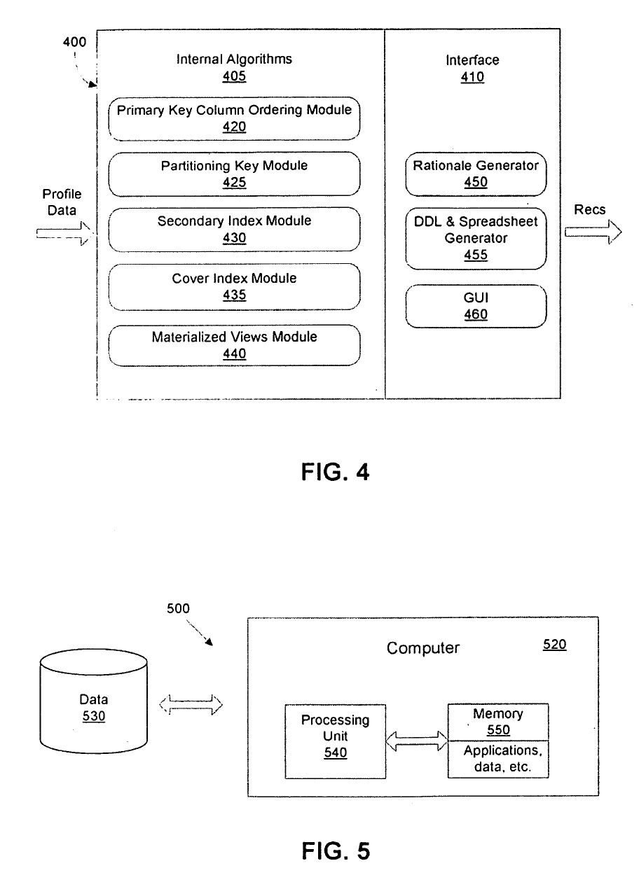

FIG. 4 is an overview of architecture of a database design advisor (DBDA) 400 in accordance with an exemplary embodiment of the present invention. The DBDA 400 has two main components: internal algorithms 405 and an interface 410. The internal algorithms include software modules for recommending five features: clustering keys, partitioning keys, secondary indexes, cover indexes, and materialized views. These modules include a primary key column ordering module 420, a partitioning key module 425, a secondary index module 430, a cover index module 435, and a materialized views module 440.

The interface component 410 includes a rational generator 450, a DDL and spreadsheet generator 455, and a graphical user interface 460. Users or DBAs use the interface to interact with the DBDA 400. By way of example, the user can set the relevant design parameters using the GUI and then view the recommendation results (for example, a threshold on the number of queries that an index should benefit to be recommended, etc.). The spreadsheets show the recommendations in a structured manner while the DDL files are actually run on a database. The rationale shows in detail how each recommendation was derived. By looking at the rationale, the user can also change recommendation results.

An objective for recommending clustering keys is to densely pack rows that satisfy many queries. In one embodiment, determining the clustering key is equivalent to ordering the columns in the primary key because the clustering key has the same set of columns as the primary key. Hence, one embodiment only orders the columns of the primary key such that the overall workload performance is the best. For example, determining the left-most column is the most significant for the overall performance because it is the first one accessed by the B-tree index of the primary key.

Clustering Key Algorithm

In one embodiment, column ordering is performed in three steps. First, columns are chosen that are candidates for being the left-most column. Recall that the left-most column has the most impact on the overall performance because it is the first column to be accessed by the primary key B-tree index. A column is a left-most column candidate if I/O's can be saved for accessing that column using the primary key B-tree.

The Clustering Key Algorithm aims at determining the minimum I/O for the overall workload based on the manner in which the rows are physically clustered (or ordered) within the given table. For any query we examine the I/O cost related to ordering the columns of the cluster key based on the query predicates. Each ordering of columns of the cluster key is a configuration. For each individual query we choose the configuration that gives us the lowest or minimum I/O cost. After calculating the costs, as detailed below, for each and every query in our workload we obtain a set of one or more cluster key configurations. We then calculate the local minimum I/O cost for each cluster key configuration.

Local Minimum I/O Cost for Configuration (i)=Sum of all the individual query costs that get the lowest cost by using that configuration.

Then we calculate the global I/O costs for each configuration by first recalculating the I/O costs for each of the queries not part of the local minimum calculation for the given configuration. We then add these costs to the local minimum and obtain the global cost for that configuration.

Lastly we compare the set of global costs and identify the cluster key configuration that results in the lowest global I/O costs. That is our global minimum cost and best cluster key configuration.

Below we outline the costing calculations.

Columns involved in restriction predicates are considered as candidates because the primary key index can be used on those columns. On the other hand, columns involved in join predicates may or may not use an index depending on the type of join. Specifically, an index can only be used on the joining columns of the inner table of a nested loop join (NLJ) and not for the joining columns of the outer tables of nested loop joins or tables involved in hash joins. The second step is to sort the left-most column candidates according to their estimated “workload costs.” The workload cost for a column reflects the number of I/O's used by the workload assuming that the column is the left-most column for clustering. For the left-most column, a primary key access is assumed. For all the other columns, full table scan accesses are assumed. The final result is to sort the non-candidates in decreasing UEC order and then append them to the sorted left-most column candidates. The three steps are shown in the Clustering Key Algorithm below:

```
Input: primary key, table T, and profile
Output: clustering key
1. Choose the left-most column candidates
  Select all restriction predicate columns
  IF IsInnerTable(T) THEN Select all join predicate columns
2. Sort candidates in decreasing EstimatedWorkloadCost(C) order where
the candidate C is the left-most column
3. Append the non-candidate column candidates in decreasing UEC order
4. Return the final ordering
```

Notice that the Clustering Key Algorithm uses two other algorithms. The first one, IsInnerTable, determines whether the joins for the table are usually nested loop joins where the table is the inner table. The second algorithm, EstimatedWorkloadCost, returns the overhead of the entire workload. Each function is elaborated below.

### EXAMPLE 1

To illustrate the Clustering Key Algorithm, suppose that there exists the table R(A,B,C) where (A,B,C) is the primary key. Suppose that two queries Q1 and Q2 are as follows:

Q1: SELECT * FROM R WHERE R.A = 5
Q2: SELECT * FROM R, S WHERE R.B = S.X.

Since A is in the restriction predicate of Q1, A is considered as a left-most column candidate. Column B is in the join predicate of Q2. If the join cost of Q2 is the smallest when the join is a nested loop join and R is the inner table, then we also include B in the left-most column candidate set. Column C is not a left-most column candidate because it is neither involved in a restriction predicate nor a join predicate. If we have the candidate set {A, B}, we then sort the candidates according to the estimated workload cost. Assuming that B saves more I/O, we have the ordering {B, A}. As a last step, we append C resulting in the final ordering {B, A, C}.

Inner Table Algorithm

The inner table algorithm is used to determine whether T is mostly involved in nested loop joins where T is the inner table. The idea is to add the costs for all joins involving T considering three cases: 1) when all joins are nested loop joins where T is the inner table, 2) when all joins are nested loop joins where T is the outer table, and 3) when all joins are hash joins. The join cost equations differ in each case. We then choose the case where the sum of the join costs is the smallest. If case 1) has the smallest sum, then we assume that table T is mostly used as the inner table of a nested loop join and thus we assume that all join predicate columns can be used by the primary key B-tree. Otherwise, we assume that all join predicate columns will not be used by the primary key B-tree.

We now explain the join costs for each join type. The three equations are shown in the Join Cost Formulas below. Notice that the algorithms use the notations cg(T) and rg(T) where T is a table. When a table is the outer table of a nested loop join or is involved in a hash join, we can only assume an index on the restriction predicate columns, which we denote by rg (restriction group). When a table is the inner table of a nested loop join, however, we assume an index not only on the restriction predicate columns but also on the joining columns. Hence, the notation cg (for column group) indicates the restriction predicate columns plus the joining columns. The blocking factor BF_{T} for table T is the number of T records that fit in one 32K block. Although the equations show the join costs for R.A=S.B (which is a single column join), they also apply to multi-column joins. The join cost formulas are as follows:

Join Cost of nested loop join NLJ(S.B = R.A) where R is the inner table:
$\frac{\vert S \vert}{{UEC}_{rg ( S )} \times {BF}_{S}} \times \frac{\vert R \vert}{{UEC}_{cg ( R )} \times {BF}_{R}} + \frac{\vert S \vert}{{UEC}_{rg ( S )} \times {BF}_{S}}$
Join Cost of nested loop join NLJ(R.A = S.B) where R is the outer table:
$\frac{\vert R \vert}{{UEC}_{rg ( R )} \times {BF}_{R}} \times \frac{\vert S \vert}{{UEC}_{cg ( S )} \times {BF}_{S}} + \frac{\vert R \vert}{{UEC}_{rg ( R )} \times {BF}_{R}}$
Join Cost of hash join HJ(S.B = R.A):
$\frac{\vert R \vert}{{UEC}_{rg ( R )} \times {BF}_{R}} + \frac{\vert S \vert}{{UEC}_{rg ( S )} \times {BF}_{S}}$

### EXAMPLE 2

Consider the Following Join:

SELECT *
FROM R,S,T
WHERE R.A = S.X AND
R.B = T.Y AND
R.C = 100 AND
S.Z = 10

We can see that rg(R)={C}, cg(R)={A,C}, rg(S)=(Z), cg(S)={X,Z}. Assume that |R|=1000, |S|=100, UEC_{C}=10, UEC_{Z}=5, UEC_{A,C}=50, UEC_{X,Z}=10, BF_{R}=1, BF_{S}=2. Then the join cost of a nested loop join between R and S where R is the inner table is:

$$\frac{\vert S \vert}{U E {C}_{rg ( S )} \times {BF}_{S}} \times \frac{\vert R \vert}{U E {C}_{cg ( R )} \times {BF}_{R}} + \frac{\vert S \vert}{U E {C}_{rg ( S )} \times {BF}_{S}} = \frac{100}{5 \times 2} \times \frac{1000}{50 \times 1} + \frac{100}{5 \times 2} = 210.$$

The join cost of a nested loop join between R and S where R is the outer table is:

$$\frac{\vert R \vert}{U E {C}_{rg ( R )} \times {BF}_{R}} \times \frac{\vert S \vert}{U E {C}_{cg ( S )} \times {BF}_{S}} + \frac{\vert R \vert}{U E {C}_{rg ( R )} \times {BF}_{R}} = \frac{1000}{10 \times 1} \times \frac{100}{10 \times 2} + \frac{1000}{10 \times 1} = 600.$$

The join cost of a hash join between R and S is:

$$\frac{\vert R \vert}{U E {C}_{rg ( R )} \times {BF}_{R}} + \frac{\vert S \vert}{U E {C}_{rg ( S )} \times {BF}_{S}} = \frac{1000}{10 \times 1} + \frac{100}{5 \times 2} = 110.$$

The inner table algorithm is the weighted sum of the join costs using the queries that contain the joins. Each join cost is weighted by the frequency of query Q that use the join divided by the number of joins inside Q. For instance, if Q has a weight of 10 and contains 2 joins of T, then each join is weighted by 10/2=5. We sum the weighted join costs as shown in the IsInnerTable algorithm below. If the total join cost is the smallest for the case where table T is the inner table of a nested loop join, we conclude that T is mostly involved in nested loop joins and that T is the inner table.

Input: table T and profile
Output: true/false

| | |
|---|---|
| 1. | Evaluate the three weighted join costs Inner, Outer, and Hash using |

the following equation:
${\sum }_{Q ∈ Queries ( T )} ( {Freq}_{Q} \times {\sum }_{J ∈ Joins ( Q , T )} \frac{JoinCost ( J , type )}{\vert Joins ( Q , T ) \vert} )$

where Queries(T) is the queries using table T, Joins(Q, T) is the joins

of query

Q using table T, and JoinCost(J, type) is one of the join cost formulas

above.

| | |
|---|---|
| 2. | IF Inner ≦ Outer and Inner ≦ Hash |
| | THEN return true |
| | ELSE return false |

### EXAMPLE 3

Suppose we have the following queries and that Q1 has a frequency of 10 while Q2 has 20:

Q1: SELECT * FROM R, S WHERE R.A = S.X
Q2: SELECT * FROM R, S, T WHERE R.A = S.X
AND R.B = T.Y AND R.C = 10.

The inner table algorithm will construct the following table:

| | Query | | Inner | Outer | Hash |
|---|---|---|---|---|---|
| Query | Frequency | Join | Cost | Cost | Cost |
| Q1 | 10 | R.A = S.X | 50 | 60 | 70 |
| Q2 | 20 | R.A = S.X | 80 | 90 | 100 |
| Q2 | 20 | R.B = T.Y | 100 | 90 | 90 |

Here, the weighted sum for the Inner Cost is thus 50*10+(80+100)/2*20 =2300 while the weighted sum of the Outer Cost and Hash Cost are 2400 and 2600, respectively. Since the Inner Cost has the smallest sum, we consider R to be an inner table of a nested loop join and that column A (which is used by a join predicate) will be accessed by the primary key B-tree.

Estimated Workload Cost Algorithm

The estimated workload cost for column C is a relative cost where we assume a primary key access to C and full table scan accesses to the rest of the columns. The formula is shown in the Estimated Workload Cost Algorithm below. The primary key access cost is a sum of three values: the equality predicate cost, the IN predicate cost, and the non-equality predicate cost. Each cost reflects the I/Os required to do a certain type of primary key access. For instance, we consider the cost of a non-equality predicate access to be one third of a full table scan. The costs are then weighted by their frequency of occurrence.

Estimated workload cost when column C is the left-most column:
$\begin{matrix}α ( C ) + {\sum }_{{C}^{′} ∈ Cols - \{ C \}} ( {Freq}_{{C}^{′}} \times FTSIO ) \\ where \\ α ( C ) = \frac{{Freq}_{=} \times \vert {T}_{\cdot } \vert}{{UEC}_{C} \times BF} + \frac{{Freq}_{IN} \times \vert T \vert \times AVGSIZE ( IN )}{{UEC}_{C} \times BF} + \frac{{Freq}_{\neq } \times FTSIO}{3}\end{matrix}$

### EXAMPLE 4

Consider the following queries:

SELECT * FROM R, S WHERE R.A = S.X AND R.B = 100
SELECT * FROM R, T WHERE R.A = T.Y.

Assuming that {A,B} is the left-most column candidate set for table R and that |T|=100, BF=1 and UEC_{A}=10, the estimated workload cost for column A is:

$$α ( C ) + {\sum }_{{C}^{′} ∈ Cols - \{ C \}}^{ } ( {Freq}_{{C}^{′}} \times FTSIO ) = \frac{{Freq}_{=} \times \vert T \vert}{U E {C}_{A} \times BF} + \frac{{Freq}_{B} \times \vert T \vert}{BF} = \frac{2 \times 100}{10 \times 1} + \frac{1 \times 100}{1} = 120.$$

Partitioning Key Recommendation

The partitioning, key recommendation module tries to maximize even distribution and then collocation. Even distribution guarantees parallel processing. Collocation minimizes the message passing between different processors by localizing joins in the same processor.

In some databases, the partitioning key must be a subset of the primary key. The reason is to avoid global indexes. Suppose that the partitioning key is a superset of the primary key. Then it could be the case that records with the same primary key value are distributed into different servers. For example, if table R(A,B) has A as the primary key but is partitioned on (A,B), records {0,0} and {0,1} could be split into two different partitions although they have the same primary key value. Since one embodiment ensures that the primary key values are unique, we will end up building a global index that checks on all the parallel servers to make sure that the uniqueness is guaranteed. This can be avoided by forcing the partitioning key to be a subset of the primary key.

Notice that we do not assign the processors for partitioning a table. This is because one embodiment either does not partition a table or partitions it on all processors.

Partitioning Key Algorithm

The partitioning keys of tables are determined in three steps. We first assign partitioning keys based on joins. The assignment can be done by sorting equi-joins according to their estimated message overheads. The estimated message overhead of a join is the number of messages passed between different processors in the case where the tables join are not collocated. The idea is to choose the join with the maximum message overhead and partition the tables with their joining columns in order to avoid the “largest penalty.” A join satisfies four conditions in order to be chosen. First, the joining columns are not skewed. Second, the joining columns are inside the primary keys. Third, the UEC values of the joining columns exceed fifty times the number of processors for sufficient distribution. Lastly, the joining columns do not conflict with other joins that were chosen before. If a joining table was already partitioned before, the joining columns are identical to the partitioning key of the table. Once a join is chosen, we partition the joining tables on the joining columns. The process is repeated until there are no more joins.

We next assign partitioning keys based on group by columns. For tables that have not been assigned partitioning keys yet, we assign group-by columns that are inside the primary key and satisfy the skew and UEC conditions above. Finally, we assign the partitioning keys based on the primary keys. For the tables that have still not been assigned partitioning keys, we assign the primary key given that the UEC (i.e., the table cardinality) is at least 50 times the number of processors (notice that the primary key is not skewed). The partitioning algorithm is shown below:

Input: the profile
Output: partitioning key for each table

| | |
|---|---|
| 1. | Sort all equi-joins (e.g., J: R.A = S.B) according to the estimated |

message exchange overhead (decreasing order):
${Freq}_{J} \times ( \frac{\vert R \vert}{{UEC}_{A}} + \frac{\vert S \vert}{{UEC}_{B}} )$

| | where Freq_{J} is the frequency of the queries using join J. |
|---|---|
| 2. | Choose the join predicate with the highest overhead (e.g., R.A = S.B) |

satisfying the four conditions:
(1) A and B are not skewed
(2) A is inside the primary key of R and B is inside the primary key of S
(3) Both UEC_{A} and UEC_{B} are larger than 50 * [number of processors]
(4) Tables R and S have not been partitioned with different partitioning
keys already

| | |
|---|---|
| 3. | Partition R on A and S on B |
| 4. | Repeat Step 2 until there are no join predicates left |
| 5. | For the tables that are still not partitioned, partition them on group-by |

columns G that satisfy the first three conditions of Step 2.

| | |
|---|---|
| 6. | For the tables that are not partitioned from Step 5, assign the primary |

key if it satisfies condition (3) in Step 2.

| | |
|---|---|
| 7. | Do not partition a table that has not been partitioned after Step 6. |

### EXAMPLE 5

Consider tables R,S,T,U, and V. Suppose the only joins are R.A=S.X (message overhead: 1000), S.B=T.Y (message overhead: 100), and T.C=U.Z (message overhead: 90). Assuming that all the joins satisfy the four conditions, we choose R.A=S.X first and partition R on A and S on X. Next, we choose T.C=U.Z (even though join S.B=T.Y has a higher message exchange overhead) because S.B=T.Y conflicts with R.A=S.X on table S. Hence, we partition T on C and U on Z. For the un-partitioned table V, we search for group-by columns and, assuming that the group-by columns form a valid partitioning key, assign the group-by columns as the partitioning key.

Handling Multi-Column Joins

The Partitioning Key Algorithm can be extended to deal with multi-column joins where more than one column of a table is involved in a join. However, calculating the query frequency becomes problematic. Not only can queries using the exact same multi-join benefit from the partitioning key, but also queries that use a “superset” of the multi-join. For instance, suppose that we use the multi join “R.A=S.X & R.B=S.Y” to partition R on {A,B} and S on {X,Y}. A query containing the multi join “R.A=S.Y & R.B=S.X & R.C=S.Z” can benefit from this partitioning because of the combination of the first two single joins. However, not all queries using superset joins benefit from the partitioning key. For example, a query containing the multi join “R.A=S.X & R.B=S.X & R.C=S.Y” cannot benefit from the partitioning keys {A,B} and {X,Y} because none of the single join combinations result in the partitioning keys. One solution is to determine whether a query using a multi join benefits from a partitioning thus requires considering all combinations of single joins inside the multi join and seeing if any combination results in the partitioning key. For example, we can see that no combination of the single joins inside “R.A=S.X & R.B=S.X & R.C=S.Y” can result in benefiting from the partitioning keys {A,B} and {X,Y}.

Secondary Index Recommendation

The secondary index module recommends secondary indexes that have significant benefit when used to access a table in comparison to a full table scan. Only the secondary indexes that have a benefit over a certain threshold given by the user are shown. Secondary indexes are based on column groups, which are columns of a table that are used at the same time in a query.

Secondary Index Algorithm

We start by identifying all the column groups that appear in the queries. We then calculate the benefit of each column group, which is the number of I/O's saved when the index is used to access the table in comparison to a full table scan. Once we choose all the indexes that give sufficient benefit, we sort the columns in each column group in decreasing UEC order. We then remove redundant column groups. A column group that is a prefix of another column group is redundant because the latter group can be used instead of the former group as an index. A column group that is a prefix of the primary key is also redundant because there is already a B-tree on the primary key. We then separate (i.e., display them separately in the GUI) column groups that are subsets (but not prefixes) of other column groups. While these subgroups are not redundant, they could still be replaced by their superset groups without much loss of benefit. Finally, column groups having the same left-most column are merged into merged groups. Merge group indexes are useful because they decrease the maintenance cost of multiple indexes while giving most of the benefit of the indexes combined. The secondary index algorithm is shown below:

```
Input: the table T and the profile data
Output: secondary indexes to use
1. Identify all column groups
2. Choose column groups where
  Benefit(column group) > [threshold]
3. Sort columns of each column group in decreasing UEC order
4. Eliminate redundant column groups that are
  (1) Prefixes of other column groups
  (2) Prefixes of the PK
5. Separate column groups that are subsets of other column groups
(display them but do not recommend by default)
6. Produce merged column groups by merging column groups that have
the same left-most column (display them but do not recommend by
default)
```

### EXAMPLE 6

Suppose we identified the columns groups {A,B}, {A,D}, {A,B,C}, and {A,C,D} whose benefits exceed a given threshold. We immediately notice that {A,B} is redundant because of {A,B,C} and remove it. We then separate {A,D} as a subgroup because it is a subset of {A,C,D}. Finally, we combine {A,B,C} and {A,C,D} into the merged group {A,B,C,D}. The indexes returned are thus {A,B,C}, {A,C,D}, {A,D} (subgroup), and {A,B,C,D} (merged group).

Column Group

A column group of a table is a maximal set of columns that can be used together in a query. For example, in the query “SELECT*FROM R,S,T WHERE R.A=S.X AND R.B=T.Y AND R.C=10”, the column groups for table R are {A,B} (when joining with S) and {A,C} (when joining with T), but not {A,B,C} because the columns are not used together in a single join. (The column group for table S is {X} and the column group for table T is {Y}.) A column group can also exist in a query that does not contain a join. For example, the query “SELECT*FROM R WHERE A=10 AND B=1” contains the column group {A,B} for R.

Benefit of Index

The benefit of an index captures the number of I/O's that can be saved for accessing a table in comparison to doing a full table scan. To calculate this cost, we need to identify which queries can actually use the index. While queries that produce column groups identical to the index can certainly use the index, queries producing column groups that are subsets of the index can also use the index. The benefit of the index is the sum of the I/O savings for all these queries weighted by their query frequencies.

The I/O savings of a query is the full table scan cost subtracted by the access cost using the index. In one embodiment, an index is composed of a B-tree that indexes a prefix of the index columns plus a physical table that stores the rest of the column values. This split (unlike the single B-tree index structures shown in textbooks) is to ensure a minimum fan-out for each B-tree entry. Too many columns for an index can result in a B-tree having many levels from the root to a leaf, resulting in that many I/O's for each index lookup. Hence, the access cost of an index is the sum of the I/O's used to read the index table plus the I/O's used to read the base table. (We do not add the access cost of the B-tree because we assume it resides in memory.) There are two ways of reading the index table: a partial scan and a full table scan. A partial scan is possible when the column group of the query is a prefix of the index columns. A full table scan is used when the column group is a subset, but not a prefix, of the index columns.

The benefit of an index is calculated as follows:

$Benefit ( I , T ) = {\sum }_{Q ∈ Queries} ( {Freq}_{Q} \times {\sum }_{g ∈ CG ( Q , T )} ( FTS - Cost ( g , I , T ) )$
Where CG(Q, T) is the column groups for T in Q and
$Cost ( g , I , T ) = \frac{\vert T \vert}{{UEC}_{g} \times {BF}_{l}} + \frac{\vert T \vert}{{UEC}_{g}} ( if g is a prefix of I )$

$or \frac{\vert T \vert}{{BF}_{l}} + \frac{\vert T \vert}{{UEC}_{g}} ( if g is a subset but not a prefix of I )$

### EXAMPLE 7

Consider the index on R, T(A,B,C) and the two queries:

SELECT * FROM R,S WHERE R.A = S.X AND R.B = 100
SELECT * FROM R WHERE R.A = 10 AND R.C = 1

Suppose that |R|=100, UEC_{A,B}=20, UEC_{A,C}=25, UEC_{A,B,C}=100. BF_{R}=1, and BF₁=10. The benefit of 1 is then:

$${\sum }_{Q ∈ Queries}^{ } ( {Freq}_{Q} \times {\sum }_{g ∈ CG ( Q , T )}^{ } ( FTS - Cost ( g , I , ) ) = FTS - ( \frac{\vert R \vert}{U E {C}_{A , B} \times {BF}_{I}} + \frac{\vert R \vert}{U E {C}_{A , B}} ) + FTS - ( \frac{\vert R \vert}{{BF}_{I}} + \frac{\vert R \vert}{U E {C}_{A , C}} ) = 100 - ( \frac{100}{20 \times 10} + \frac{100}{20} ) + 100 - ( \frac{100}{10} + \frac{100}{25} ) = 80.5 .$$

Cover Indexes

A cover index is a vertical partition of a table, and is used to “cover” all the columns used in a query saving the time to read base table records from the disk. A query is covered by a cover index if all the columns the query uses (both in the selection statements and predicates) are included in the cover index. It is desirable to have cover indexes that use only a small portion (say 20%) of the columns of its table and yet cover a large portion (say 10%) of the queries.

Cover Index Algorithm

The idea of the cover index algorithm is to find the minimal cover of columns that covers a maximal number of queries. We first sort all the columns of a table according to the query frequency of each column. We then choose a prefix of the sorted columns starting from size 1 and increase the window by one column until we arrive at a valid cover index. The size of the cover index should not exceed a certain threshold (say 20% of the table columns), so once the prefix size becomes too large, we return an empty recommendation. If we do find a prefix of columns that covers a large portion of the queries, we choose that prefix as the columns of the cover index and then start sorting the columns in order to optimize the access time to the cover index. For the ordering algorithm, we simply apply the clustering key algorithm to the cover index columns, as shown below:

Input: the table T and the profile data
Output: cover index to use
1. Sort all the columns in T according to their query frequencies
2. Select a prefix of the sorted columns starting from one column
3. If |prefix| > |T.Columns| * [threshold], return an empty
recommendation
4. If the prefix covers more than a certain percentage of the queries, the
current prefix of the sorted columns becomes the cover index
5. Order the columns of the cover index using the clustering key algorithm
(See Section 4.1), the only difference being that we are now sorting the
cover index columns instead of the primary key columns

### EXAMPLE 8

Suppose we are given several queries with the columns in T they use as follows:

Q1: {A,B,C}
Q2: {B,C,D}
Q3: {D,E}

Assuming each query has a frequency of 1, the sorted columns with frequencies is then {(B,2), (C,2), (D,2), (A,1),(E,1)}. Assume that we allow 80% of the columns to be used. We start from the first prefix {B} and observe that no queries are covered. We continue extending the prefix until we arrive at {B,C,D}. Clearly, Q2 is covered by {B,C,D}. However, suppose we require a coverage of at least 50% of the queries. We then extend the prefix to {B,C,D,A}. Since this prefix covers both Q1 and Q2, we have found a valid cover index. We then start sorting the columns of {B,C,D,A} according to the clustering key algorithm. The final result is the cover index for table T.

Column Ordering

Notice that the column ordering for the cover index is different from the ordering for secondary indexes. (Recall that the columns of a secondary index are sorted by decreasing UEC order). While the ordering of the secondary index reflects the access order of column group columns, the ordering of cover indexes needs to be optimized for reading all the columns used in a query. For example, since the predicate columns are accessed before the selection statement columns, it is desirable to order the predicate columns before the selection statement columns. Among the predicate columns, we order both join and restriction predicate columns together if the table of the cover index is usually the inner table of a nested loop join. Otherwise, we order the restriction predicate columns first and then append the join predicate columns. Hence, we are essentially running the clustering key algorithm as if the cover index were the primary key.

Dimensional Databases

In one embodiment, a database follows a dimensional database model, consisting of fact and dimension tables. A fact table contains the foreign keys for dimension tables. In most of the cases, a join between a fact table and dimension table involves the foreign key of the fact table and primary key of the dimension table. Dimension tables can also connect with other dimension tables, making the schema a snowflake schema. The following section (Augmenting Primary Keys) shows how having a dimensional model affects the designing process.

Augmenting Primary Keys

In one embodiment, an exception where the DBDA augments the primary key of a table is when the table is a fact table and the primary key of the table does not include the foreign key of joining dimension tables. Normally, a fact table identifies its columns using the foreign keys of its dimension tables. However, in some cases, the fact table contains a separate id column that acts as the primary key. This incorrect design choice forces the fact table to be partitioned on the id column (which is the only column inside the primary key) and does not give any collocation between joining fact tables and dimension tables. In order to have collocation, we augment the primary key with the foreign key of the dimension table before running the recommendations.

Interactions Between Features

Until now, exemplary embodiments have separately recommended the fives features: clustering keys, partitioning keys, secondary indexes, cover indexes, and materialized views. However, some recommendations of a feature can affect the recommendations of another feature. For example, building a good cover index for a table could remove the need to build any secondary indexes.

The degree of interactions between features varies depending on the features. While secondary indexes and cover indexes can influence each other to a great degree, partitioning keys and secondary indexes do not affect each other much. In one embodiment, the DBDA relies on the DBA to resolve the interactions. Although the DBDA recommends secondary indexes and cover indexes sequentially, the DBA can simply choose the most important indexes while considering the memory resource constraints.

Embodiments in accordance with the present invention are utilized in or include a variety of systems, methods, and apparatus. FIG. 5 illustrates an exemplary embodiment as a computer system 500 for being or utilizing one or more of the computers, methods, flow diagrams and/or aspects of exemplary embodiments in accordance with the present invention.

The system 500 includes a computer system 520 (such as a host or client computer) and a repository, warehouse, or database 530. The computer system 520 comprises a processing unit 540 (such as one or more processors of central processing units, CPUs) for controlling the overall operation of memory 550 (such as random access memory (RAM) for temporary data storage and read only memory (ROM) for permanent data storage). The memory 550, for example, stores applications, data, control programs, algorithms (including diagrams and methods discussed herein), and other data associated with the computer system 520. The processing unit 540 communicates with memory 550 and data base 530 and many other components via buses, networks, etc.

Embodiments in accordance with the present invention are not limited to any particular type or number of databases and/or computer systems. The computer system, for example, includes various portable and non-portable computers and/or electronic devices. Exemplary computer systems include, but are not limited to, computers (portable and non-portable), servers, main frame computers, distributed computing devices, laptops, and other electronic devices and systems whether such devices and systems are portable or non-portable.

Definitions:

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

The “clustering key” or “primary key column ordering” determines physical clustering of the table. Depending on how well the data is clustered with respect to the workload, exemplary embodiments densely pack rows that satisfy many queries and thus save I/Os. One embodiment clusters on all the columns in the table in some order. However, it is usually the case that only the left-most columns in the clustering key affect the performance. A reasonable approach is to cluster only on the columns of the primary key based on the assumption that most of the query predicates use columns in the primary key. Of course, it could be more desirable to cluster on columns outside the primary key if many queries use those columns in their predicates.

A “cover index” is a vertical partition of a base table that covers all columns used by certain queries. Using a cover index, a query can save the time to access the base table on the disk.

A “database” is a structured collection of records or data that are stored in a computer system so that a computer program or person using, a query language can consult it to retrieve records and/or answer queries. Records retrieved in response to queries provide information used to make decisions. Further, the actual collection of records is the database, whereas the DMS is the software that manages the database.

A “database administrator” or “DBA” is a person who defines or manages a database or controls access to the database.

A “database management system” or “DMS” is computer software designed to manage databases.

A “flat file” is a computer file that can only be sequentially read or written. Flat files have one or more records that contain one or more field instances.

The “partitioning key” determines the horizontal partitioning of the table rows. The two exemplary goals to achieve in partitioning are even distribution and collocation. Columns that have a high frequency of usage, high UEC (unique entry count, also known as cardinality), and low skew are good candidates for the partitioning key. On the other hand, it is desirable to collocate the data from different tables that will be joined together in order to minimize the number of messages passed between different central processing units (CPUs). In one embodiment, desirable properties for partitioning keys are high frequency of usage, high UEC, and low skew. A partitioning key should be involved in an equality join to achieve collocation. Another desirable case is when the partitioning key consists of group-by columns. In this case, certain aggregations on the same value or the key can be performed in parallel and locally by each CPU.

The “primary key” of a table uniquely identifies a record. One embodiment assumes that the primary key is already given by the user. The primary key is not augmented with the exception where a fact table has its primary key augmented with the foreign key of a dimension table.

A “relational database” is a database having a collection of relations (or tables) that conform to a relational model and refers to a database's data and schema (i.e., the structure of how the data is arranged).

A “secondary index” is a separate B-tree structure (with an additional index table if there are too many columns to fit in the B-tree block) that can be used to quickly access columns outside the primary key. A desirable index is one that is used frequently and has a large I/O benefit compared to a full table scan, the alternative way of accessing the column. On the other hand, having too many indexes increases the maintenance cost during record updates.

A “table” is a logical representation of data in a database in which a set of records is represented as a sequence of rows, and the set of fields common to all the records is represented as a series of columns. The intersection of a row and column represents the data value of a particular field of a particular record.

A “schema” is a named collection of database objects (for example, tables, views and indexes). The schema describes the objects in the database and relationships among such objects.

“Structured Query Language” or “SQL” is a database computer language designed for the retrieval and management of data in a relational database management system, database schema creation and modification, and database object access control management. SQL provides a programming language for querying and modifying data and managing databases (for example, retrieve, insert, update, and delete data, and perform management and administrative functions.

A “workload” is a set of queries used for the data warehouse. For each query q, exemplary embodiments assign a weight w_{q} that represents the frequency or importance of q. Depending on the type of query (SELECT, INSERT, or UPDATE), the cost evaluations change. For a selection queries, one embodiment pinpoints or locates the records to be read using minimal input/outputs (I/Os). For insertion queries, it is desirable to add records at the end of tables and thus avoid managing overhead, such as splitting blocks.

In one exemplary embodiment, one or more blocks or steps discussed herein are automated. In other words, apparatus, systems, and methods occur automatically.

The methods in accordance with exemplary embodiments of the present invention are provided as examples and should not be construed to limit other embodiments within the scope of the invention. For instance, blocks in flow diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, Such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
analyzing tables with a computer; and
generating, with the computer, recommendations for an initial design of a database before the database is actually built and without using a database management system (DMS) installation.

2) The method of claim 1 further comprising:
recommending a clustering key that determines ordering of columns in the tables;
recommending a partitioning key that determines how the tables are divided;
recommending an index to increase access time for queries to the tables.

3) The method of claim 1 further comprising, recommending which queries to materialize so results for subsequent and equivalent queries are already stored in memory.

4) The method of claim 1 further comprising, automatically creating code to implement a recommendation in the database upon receiving approval from a user to accept the recommendation.

5) The method of claim 1 further comprising, generating, with the computer, rationale that explains why a recommendation is provided to assist a user in deciding whether to accept or reject the recommendation.

6) A tangible computer readable storage medium having instructions for causing a computer to execute a method, comprising:
analyzing files with records and tables to generate recommendations for an initial design of a database before the database is constructed; and
providing the recommendations to user before the database is installed for operation.

7) The tangible computer readable storage medium of claim 6 further comprising, analyzing queries collected by a profiling tool to determine candidate physical features while the database is being designed.

8) The tangible computer readable storage medium of claim 6 further comprising, automatically creating a Data Definition Language (DDL) script that creates a database schema when one of the recommendations is accepted for the database.

9) The tangible computer readable storage medium of claim 6, wherein the recommendations include both a clustering key and a partitioning key.

10) The tangible computer readable storage medium of claim 6, wherein the recommendations include a secondary index that is a B-tree that speeds up access to columns when a query is executed on the database after the database is designed and loaded.

11) A computer system, comprising:
a memory for storing an algorithm; and
a processor for executing the algorithm to:
analyze files with records and tables to generate recommendations for an initial physical design of a database before the database is created and loaded for operation.

12) The computer system of claim 11, wherein the processor further executes the algorithm to generate rationale that explains why a recommendation is generated.

13) The computer system of claim 11, wherein the recommendations include clustering keys, partitioning keys, and indexes for the tables.

14) The computer system of claim 11, wherein the recommendations are generated without making calls to a database management system (DBMS) optimizer.

15) The computer system of claim 11, wherein the recommendations are provided before the records and the tables are loaded in a database and before a database system installation.
